(19) United States
(12) Patent Application Publication
(10) Pub. No.: US 2025/0007811 A1
(43) Pub. Date: Jan. 2, 2025

(54) MONITORING APPARATUS, MONITORING METHOD, AND PROGRAM

(71) Applicant: NEC Corporation, Tokyo (JP)

(72) Inventors: Yuma KADOWAKI, Tokyo (JP); Yuki Ashino, Tokyo (JP)

(73) Assignee: NEC Corporation, Tokyo (JP)

(21) Appl. No.: 18/754,298

(22) Filed: Jun. 26, 2024

(30) Foreign Application Priority Data
Jun. 29, 2023 (JP) 2023-107383

(51) Int. Cl. H04L 43/12

(52) U.S. Cl. CPC H04L 43/12

(57) ABSTRACT

A monitoring apparatus, includes: a target node storage part that stores a target node(s), which is a probe target(s) in a network; a probe part that acquires a status of the target node(s) via the network and probes the status; a policy storage part that stores a probe policy(ies) defining a policy(ies) for probing the probe target node(s); and a policy selection part that selects one or more of the probe policy(ies) based on the status of the target node(s); wherein the probe part probes the target node(s) stored in the target node storage part based on the selected policy(ies).

### FIELD

### Reference to Related Application

The present invention is based upon and claims the benefit of the priority of Japanese patent application No. 2023-107383, filed on Jun. 29, 2023, the disclosure of which is incorporated herein in its entirety by reference thereto.

The present invention relates to a monitoring apparatus, a monitoring method, and a program that can determine the status of a network apparatus(es) in detail and easily from a remote location.

### BACKGROUND

Many nodes (terminals, servers, routers, switches, etc.,) are mutually connected on networks, and it is almost impossible to determine the whole picture. This is because all networks and nodes being used are not necessarily owned and managed by a single party. That is, if a failure occurs in a network or a computer managed by one party, unless another party communicates with this one party, there is no way for the another party to know the occurrence of this failure. Thus, in order to monitor the status of networks or computers managed by other parties, there are cases in which a party regularly executes communications (probe communications), expecting responses from the nodes, etc., of these other parties.

Patent Literature (PTL) 1 discloses an invention in which an apparatus such as a network probe server probes the status of communication paths of a network as a probe target. According to this invention, order information indicating the order in which target apparatuses (nodes) are probed is stored per network. Based on the order, the network probe server probes an individual communication path on which target apparatuses are located. To probe the individual communication path, first, the network probe server sequentially transmits request signals using, for example, ping commands, and next determines whether there is a response from the individual target apparatus. In this way, the network probe server determines whether the network probe server can transmit a probe command to the individual target apparatus. Next, the server executes a probe command based on a stored command table and probes the status of the communication path.
PTL 1: Japanese Kokai (Unexamined) Patent Application No. JP2018-157292A

### SUMMARY

The disclosure of the above PTL 1 is incorporated herein in its entirety by reference thereto. The following analysis has been made by the present inventors.

As described above, according to the invention disclosed in PTL 1, because a management entity embodied as the network probe server of PTL 1 executes probe communications on the target apparatuses in an integrated manner, the time and effort for the management is consolidated and reduced. In addition, even when an abnormality occurs on a communication path, the management entity can detect the abnormality simply from the probe time interval. Thus, the management entity can promptly take measures by setting an appropriate probe interval.

However, first, although the invention disclosed in PTL 1 does not mention the probe interval, which is the time interval at which the probe communications are executed, the resolution for detecting an abnormality such as a failure deteriorates as the probe interval is increased. However, if the probe interval is decreased, although the resolution for detecting an abnormality improves, the communication amount increases, possibly causing congestion in the path.

Second, even when an abnormality is detected, this abnormality cannot be geographically located. The probing disclosed in PTL 1 is limited to the target apparatuses in a finite list. For example, when a failure is detected at a particular IP address, the geographical location can be determined by referring to a list in which IP addresses, server names, installation locations, etc., are associated with one another. Next, by locating the target apparatus on a map and outputting the map via a display device, it is possible to easily determine the location of the abnormality.

However, in the case of an open network environment that does not have the above-described limitation (management boundary) and that includes domains managed by other parties, it is not easy for any conventional technology to associate a network identifier such as an IP address with a geographical location.

Thus, it is an object in one aspect of the present invention to provide a monitoring apparatus, a monitoring method, and a program that can determine the status of a network apparatus(es) in detail and easily from a remote location.

According to a first aspect of the present invention, there is provided a monitoring apparatus, including: a target node storage part that stores a target node(s), which is a probe target(s) in a network; a probe part that acquires a status of the target node(s) via the network and probes the status; a policy storage part that stores a probe policy(ies) defining a policy(ies) for probing the probe target(s); and a policy selection part that selects one or more of the probe policy(ies) based on the status of the target node(s); wherein the probe part probes the target node(s) stored in the target node storage part based on the selected policy(ies).

According to a second aspect of the present invention, there is provided, a monitoring method, causing a computer to execute: acquiring a target node(s), which is a probe target(s) in a network; acquiring a status of the target node(s) via the network and probing the status; acquiring a probe policy(ies) defining a policy(ies) for probing the probe target(s); selecting one or more of the probe policy(ies) based on the status of the target node(s); and probing the target node(s) based on the selected policy(ies).

According to a third aspect of the present invention, there is provided, a program, causing a computer to execute processings of: acquiring a target node(s), which is a probe target(s) in a network; acquiring a status of the target node(s) via the network and probing the status; acquiring a probe policy(ies) defining a policy(ies) for probing the probe target(s); selecting one or more of the probe policy(ies) based on the status of the target node(s); and probing the target node(s) based on the selected policy(ies).

The program can be recorded in a computer-readable storage medium. The storage medium may be a non-transitory storage medium such as a semiconductor memory, a hard disk, a magnetic recording medium, or an optical recording medium. The present invention can be embodied as a computer program product.

According to the individual aspects of the present invention, there are provided a monitoring apparatus, a monitoring method, and a program that can determine the status of a network apparatus(es) in detail and easily from a remote location.

### BRIEF DESCRIPTION OF DRAWINGS

FIG. 1 is a block diagram illustrating an example of a configuration of a monitoring apparatus according to an example embodiment.

FIG. 2 is a diagram illustrating an example of a list stored in a target node storage part of a monitoring apparatus according to a first example embodiment.

FIG. 3 is a diagram illustrating an example of a policy table stored in a policy storage part of the monitoring apparatus according to the first example embodiment.

FIG. 4 is a flowchart illustrating an operation of the monitoring apparatus according to the first example embodiment.

FIG. 5 is a schematic diagram illustrating an example of a hardware configuration of the monitoring apparatus according to the first example embodiment.

FIG. 6 is a block diagram illustrating an example of a configuration of a monitoring apparatus according to a second example embodiment.

FIGS. 7A to 7C are diagrams illustrating visualization results obtained by a node visualization part.

FIG. 8 is a schematic diagram illustrating an example of a map outputted by the node visualization part.

FIG. 9 is a flowchart illustrating an operation of the monitoring apparatus according to the second example embodiment, in particular, operations of a probe part, a ranging and locating part, and the node visualization part.

FIGS. 10A and 10B are diagrams illustrating an outline of processing of a monitoring apparatus 10 according to a third example embodiment.

FIG. 11 is a diagram illustrating an example of a target node list stored in a target node storage part.

FIG. 12 is a diagram illustrating an example of a target node selection mode by a target node selection part.

FIG. 13 is a diagram illustrating an example of policies applied according to a fourth example embodiment.

FIGS. 14A and 14B are each a flowchart illustrating an operation of a monitoring apparatus according to the fourth example embodiment.

FIG. 15 is a diagram illustrating an outline of processing according to a fifth example embodiment.

### EXAMPLE EMBODIMENTS

First, an outline of an example embodiment will be described. In the following outline, various elements are denoted by reference characters for the sake of convenience. That is, the following reference characters are used only as examples to facilitate understanding of the present invention. Thus, the description of the outline is not intended to impose any limitations.

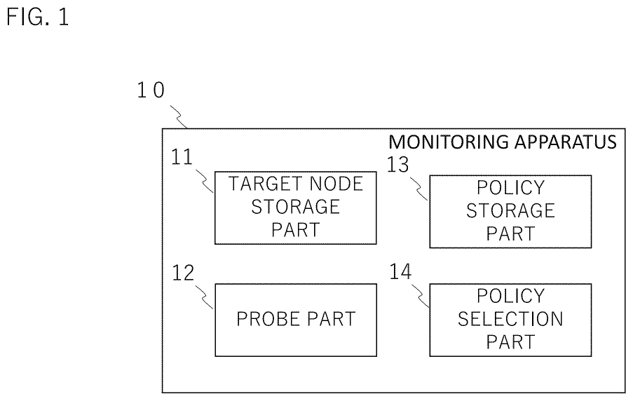

FIG. 1 is a block diagram illustrating an example of a configuration of a monitoring apparatus according to an example embodiment. A monitoring apparatus 10 according to this example embodiment includes a target node storage part 11, a probe part 12, a policy storage part 13, and a policy selection part 14.

The target node storage part 11 stores a target node(s), which is a probe target(s) in a network. The probe part 12 acquires the status of the target node(s) via the network and probes the status. The policy storage part 13 stores a probe policy(ies) defining a policy(ies) for probing the probe target(s). The policy selection part 14 selects one or more of the probe policy(ies) based on the status of the target node(s). The probe part 12 probes the target node(s) stored in the target node storage part 11 based on the selected policy(ies).

As described above, the monitoring apparatus according to the example embodiment can probe the target node(s) based on the probe policy(ies) defining a policy(ies) for probing the probe target(s). The monitoring apparatus probes the target node(s), which is the probe target(s), based on a certain policy(ies), not uniformly. Thus, the monitoring apparatus can execute adaptive probing more suitably for the state of the network. Therefore, the status of a network apparatus(es) can be determined in more detail.

### First Example Embodiment

### [Configuration of Apparatus]

An example of a configuration of a monitoring apparatus according to a first example embodiment is the same as the example of the configuration according to the above-described example embodiment illustrated in FIG. 1. As in the above-described example embodiment, a monitoring apparatus 10 according to the first example embodiment includes a target node storage part 11, a probe part 12, a policy storage part 13, and a policy selection part 14. A feature according to the present example embodiment is that the probe part 12 transmits a probe packet(s) based on a selected policy(ies), and the policy selection part 14 selects a policy(ies) based on a transmission result(s) of the probe packet(s).

The target node storage part 11 stores a target node(s), which is a probe target(s) in a network. This “network” may be a closed network such as a local area network (LAN) that can be accessed by only certain people or may be an open network such as the Internet that can be accessed by anybody. The “target node(s)” is a probe target node(s), and “node(s)” refers to network apparatus(es) having a network interface on the network. Examples of “node(s)” include terminals, servers, routers, and switches.

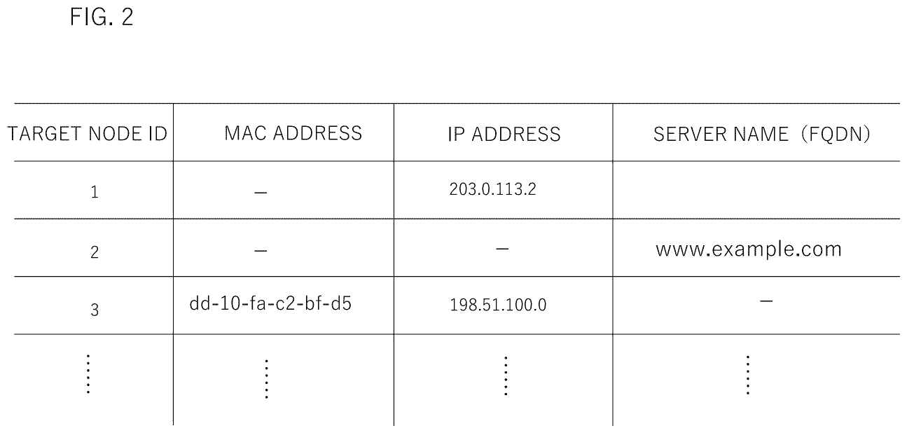

To determine the target node(s), the target node storage part 11 includes at least a list storing IP addresses, MAC addresses, etc., which are identification values in the network. FIG. 2 illustrates an example of the list stored in the target node storage part 11. As illustrated in FIG. 2, for example, an IP address, a server name (FQDN), a MAC address, or a combination of these items of information is used as an identification value.

The probe part 12 acquires the status of the target node(s) via the network and probes the status. Concretely, the probe part 12 transmits a probe packet(s) to the target node(s) based on a policy(ies) selected by the policy selection part 14, which will be described below. The probe packet(s) is transmitted by, for example, a ping command(s) using Internet Control Message Protocol (ICMP), a traceroute (tracert) command(s) transmitted by using ICMP or User Datagram Protocol (UDP), or application software that can use Simple Network Management Protocol (SNMP), etc.

Information acquired by the probe part 12 includes, for example, an error, a packet ross rate, a statistical summary of results (a minimum, maximum, or average round-trip time), etc. The probe part 12 acquires a round-trip time (RTT) value(s) as the transmission result(s) of the probe packet(s). The policy selection part 14, which will be described below, may select a policy(ies) based on these RTT values.

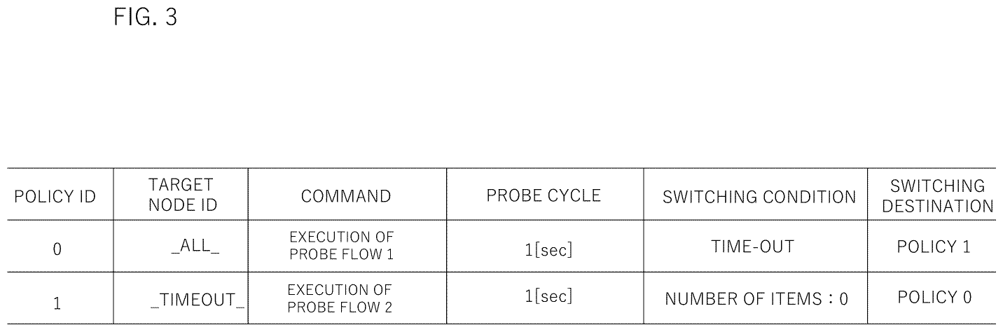

The policy storage part 13 stores a probe policy(ies) defining a policy(ies) for probing the probe target(s). This “policy(ies)” is a policy(ies) for probing the probe target(s). FIG. 3 is a diagram illustrating an example of a policy table stored in the policy storage part 13. As illustrated in FIG. 3, a policy ID and policy contents are stored in association with one another. The “contents” may include items such as a target node ID, a command to be executed, a probe cycle, a policy switching condition, and a switching destination policy applied when the switching condition is met.

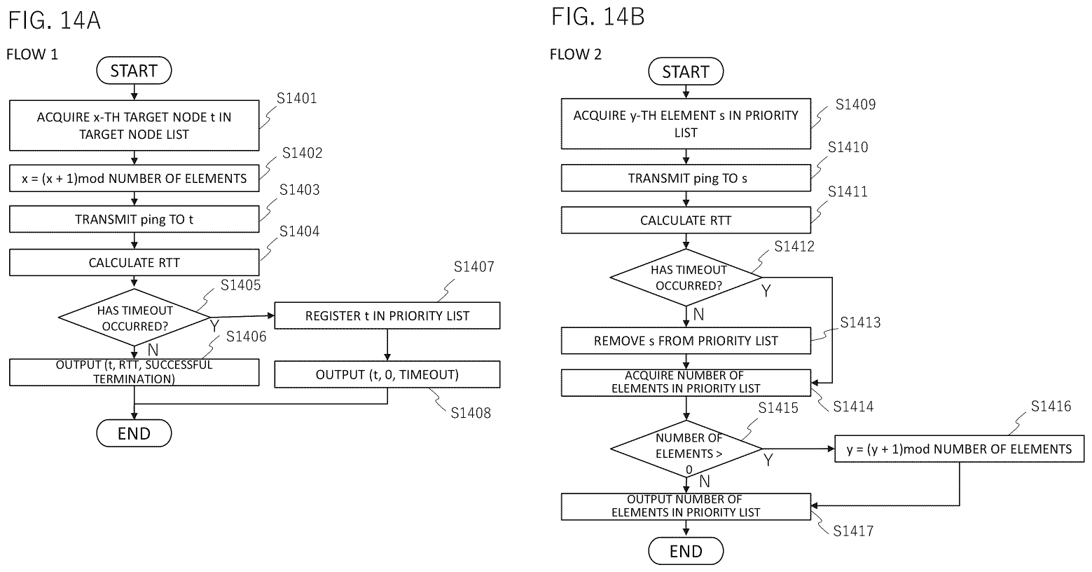

When policy ID:0 illustrated in FIG. 3 is selected, probe flow 1 is executed on all the target node IDs (token:_ALL_). This “probe flow” represents a concrete content of a command executed by the probe part 12 based on the policy selection by the policy selection part 14, which will be described below. An example of “probe flow 1” may be flow 1 in FIG. 14(a), and an example of “probe flow 2” may be flow 2 in FIG. 14(b). Because the probe cycle of policy ID:0 is 1 [sec], probe packets are transmitted every second. In this case, for example, if a response to a probe packet times out, policy ID:1 is selected. If policy ID:1 is selected, probe flow 2 is executed on a group of target nodes that have timed out (token:_TIMEOUT_). After the execution, if the number of target items reaches 0, that is, if a probe packet has been transmitted to each target node that has timed out and if a response packet therefrom has been received before a timeout, policy ID:0 is selected again.

The policy selection part 14 selects one or more of the probe policy(ies) based on the status of the target node(s). Concretely, the policy selection part 14 selects a policy(ies) based on the transmission result(s) of the probe packet(s). For example, the policy selection part 14 may select a policy by determining whether an RTT value, which is a transmission result of a probe packet, is a predetermined value or less. The policy selection part 14 refers to the items “switching condition” and “switching destination” in the policy table illustrated in FIG. 3.

### [Description of Operation]

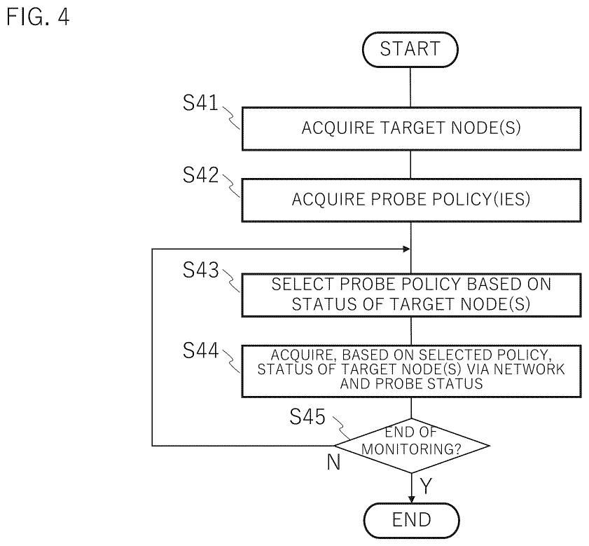

FIG. 4 is a flowchart illustrating an operation of the monitoring apparatus 10 according to the first example embodiment. As illustrated in FIG. 4, when the monitoring apparatus 10 starts to operate, the monitoring apparatus 10 accesses a storage area and acquires a target node(s) (step S41). Next, the monitoring apparatus 10 accesses the storage area again and acquires a probe policy(ies) (step S42). The target node(s) and the probe policy(ies) may be those that have been acquired by the monitoring apparatus 10 via a network and temporarily stored in a storage area in advance.

Next, the monitoring apparatus 10 selects a probe policy based on the status of the target node(s) (step S43). When selection of a probe policy is performed for the first time, because “the status of the target node(s)” is empty, a default value(s) may be prepared, and based on the default value(s), a probe policy may be selected.

Next, based on the selected policy, the monitoring apparatus 10 acquires the status of the target node(s) via the network and probes the status. Next, the monitoring apparatus 10 determines whether or not to end the monitoring. If the monitoring apparatus 10 determines to end the monitoring (Y in step S45), the monitoring apparatus 10 ends the monitoring. Otherwise (N in step S45), the monitoring apparatus 10 executes the probe policy selection step again (step S43).

### [Hardware Configuration]

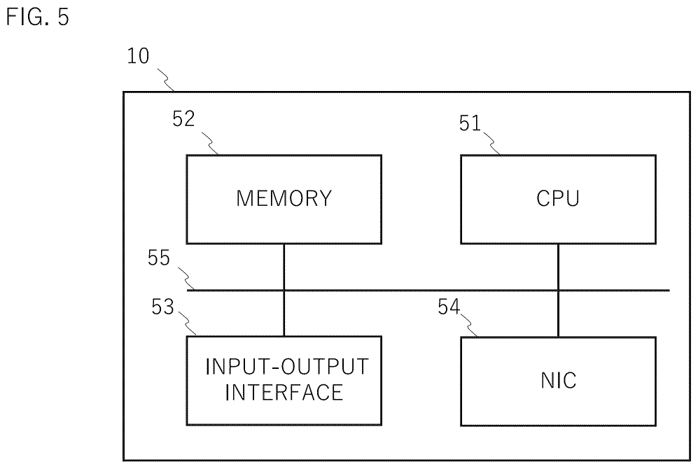

Next, a hardware configuration of the monitoring apparatus 10 according to the first example embodiment will be described. FIG. 5 is a block diagram illustrating an example of a hardware configuration of the monitoring apparatus 10 according to the first example embodiment 10.

The monitoring apparatus 10 can be constituted by an information processing apparatus (a computer), and has a configuration that is illustrated in FIG. 5 as an example. For example, the monitoring apparatus 10 includes a central processing unit (CPU) 51, a memory 52, an input-output interface 53, and a network interface card (NIC) 54 serving as communication means, which are mutually connected by an internal bus 55.

The configuration illustrated in FIG. 5 is not intended to limit the hardware configuration of the individual devices constituting the monitoring apparatus 10. The monitoring apparatus 10 may include hardware not illustrated in FIG. 5 or may be configured without the input-output interface 53, depending on the need. In addition, for example, the number of CPUs included in the monitoring apparatus 10 is not limited to the example illustrated in FIG. 5. For example, a plurality of CPUs may be included in the individual device.

The memory 52 is a random access memory (RAM), a read-only memory (ROM), or an auxiliary storage device (a hard disk, for example).

The input-output interface 53 is means used as an interface for a display device or an input device not illustrated. The display device is, for example, a liquid crystal display. The input device is, for example, a device such as a keyboard or a mouse that receives user operations.

The function of the monitoring apparatus 10 is realized by processing modules such as an acquisition program, a selection program, a probe program, and a target node list and a probe policy table stored, for example, in the memory 52.

The above-described processing modules are each realized, for example, by causing the CPU 51 to execute a program stored in the memory 52. In addition, the individual programs may be updated by downloading program updates via a network or by using a storage medium storing program updates. The processing modules may be realized by semiconductor chips. That is, the monitoring apparatus 10 has means for executing the functions of the above-described processing modules by using some hardware and/or software.

### [Hardware Operation]

When the monitoring apparatus 10 starts to operate, the acquisition program is read out from the memory 52, and becomes executable by the CPU 51. This program accesses a storage area in its host apparatus, another apparatus, or a system, and acquires a target node list and a probe policy table. The acquired data is stored in the memory 52.

Next, the selection program is read out from the memory 52, and becomes executable by the CPU 51. By then, the probe program has also been read out from the memory 52, and has also become executable by the CPU 51. The selection program and the probe program read out the probe policy table stored in the memory 52, and the selection program sends a policy ID that needs to be selected to the probe program. In an initial state, there is no policy that has been selected. Thus, for example, policy ID:0 in FIG. 3 is selected as a default value and is sent to the probe program. The selection program refers to the switching condition and the switching destination in the probe policy table. If the switching condition is met during the operation of the probe program, the selection program selects the switching destination policy and sends the policy to the probe program. The probe program refers to the probe policy table, refers to the record corresponding to the sent policy ID, reads the individual fields, and executes the contents described in the fields. Since the monitoring apparatus 10 executes the probing via the network, the monitoring apparatus 10 repeats the above processing via the NIC 54 until the end of the monitoring.

### [Description of Advantageous Effects]

As described above, the monitoring apparatus 10 according to the present example embodiment can execute probing while switching probe policies based on the status of a target node(s). In this way, the monitoring apparatus 10 can execute probing based on the status of the target node(s), and can execute adaptive probing more suitably for the state of the network. Therefore, the status of a network apparatus(es) can be determined in more detail.

### Second Example Embodiment

A second example embodiment describes a monitoring apparatus that can determine the location(s) of a probe target node(s) in a network and the distance(s) between a pair(s) of nodes, and that can visualize the location(s) of the target node(s) and the distance(s) between the pair(s) of nodes.

### [Configuration of Apparatus]

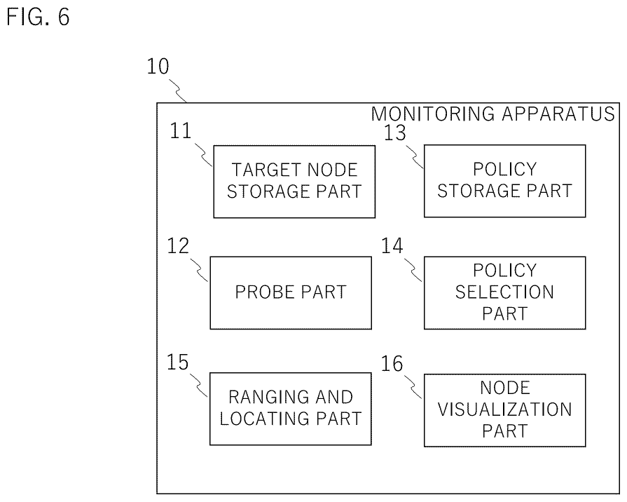

FIG. 6 is a diagram illustrating an example of a configuration of a monitoring apparatus 10 according to a second example embodiment. As illustrated in FIG. 6, the monitoring apparatus 10 according to the present example embodiment includes a target node storage part 11, a probe part 12, a policy storage part 13, and a policy selection part 14. Because these components have already been described in the above-described example embodiment, description thereof will be omitted. A feature of the monitoring apparatus 10 according to the present example embodiment is that the monitoring apparatus 10 includes a ranging and locating part 15 and a node visualization part 16, in addition to the components of the monitoring apparatus 10 according to the above-described example embodiment.

The ranging and locating part 15 determines the distance(s) between a pair(s) of nodes in a network and the locations of nodes. The “distance(s) between a pair(s) of nodes” refers to the physical distance(s) between a pair(s) of nodes placed on a path(s) provided by a network. The “locations of nodes” refers to the physical locations of nodes (the locations that can be indicated on a map). It is possible to determine the physical location(s) of a node(s) by using the physical distance(s) between a pair(s) of nodes.

The probe part 12 of the monitoring apparatus 10 transmits a probe packet to a target node, and receives a response packet R as a transmission result. Next, the ranging (i.e., distance-measuring) and locating (i.e., location-finding) part 15 acquires a transmission time Tp at which the probe packet P has been transmitted and a reception time Tr at which the response packet R has been received. Next, a round-trip time RTT is calculated by using the transmission time Tp, the reception time Tr, and equation (1).

Round-trip time RTT=Reception time Tr−Transmission time Tp (1)

The ranging and locating part 15 acquires a medium speed Vm of the transmission medium between the monitoring apparatus 10 and the target node. The distance to the target node can be calculated by using equation (2).

Distance r1=(Medium speed Vm×Round-trip time RTT)÷2 (2)

In the same way, in addition to the distance r1, distances (r2, r3) from other two points (which may be nodes newly acquired through probe packets from the probe part 12) to the target node are calculated. That is, the coordinate (x,y) of the location of the target node can be calculated based on so-called triangulation. That is, coordinate (x,y) of the intersection of the circles having coordinates (x1,y1), (x2,y2), (x3,y3) of the three points as their respective centers and having the radii r1, r2, and r3 are calculated.

$${( x - x 1 )}^{∧} 2 + {( y - y 1 )}^{∧} 2 = r {1}^{∧} 2$$

$${( x - x 2 )}^{∧} 2 + {( y - y 2 )}^{∧} 2 = r {2}^{∧} 2$$

$${( x - x 3 )}^{∧} 2 + {( y - y 3 )}^{∧} 2 = r {3}^{∧} 2$$

By solving the above x and y, the coordinate (x,y) of the location of the target node can be obtained.

As described above, the ranging and locating part 15 can determine the distance(s) between a pair(s) of nodes in a network and the locations of nodes by using the transmission result(s) of a probe packet(s) transmitted by the probe part 12.

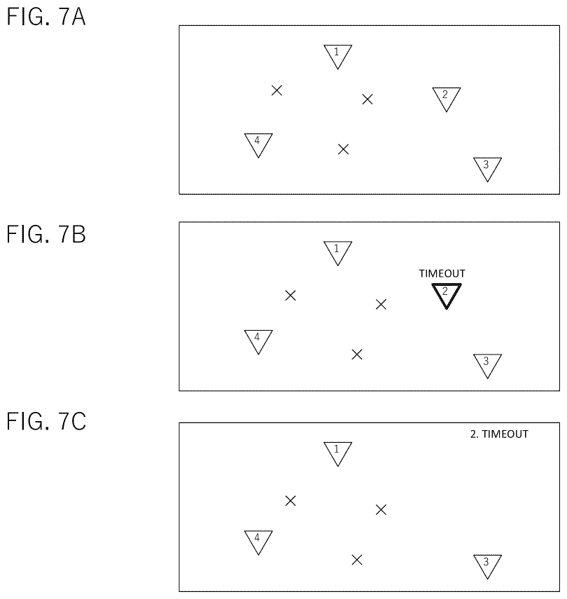

The node visualization part 16 visualize nodes by placing the nodes on a map, from the locations of nodes in the network and the distance(s) between a pair(s) of nodes, and outputs the map. FIGS. 7A to 7C each illustrate an example of a visualization result by the node visualization part 16. FIG. 7A illustrates three observation points indicated by “x” and nodes 1 to 4 of which the locations have been determined by the ranging and locating part 15 after the probe part 12 transmits and receives probe packets. The observation points indicated by “x” may also be included as the target nodes.

FIG. 7B illustrates an output example in which the transmission result of a probe packet indicates that the node 2 has timed out. Although the node 2 had responded at the beginning of the probing within a predetermined time, the most recent transmission result indicates that the node 2 has not responded within the predetermined time and has timed out. In FIG. 7C, because the node 2 has already timed out at the beginning of the probing and has not responded yet thereafter, that is, because the ranging and locating is impossible, a character string “timeout” is displayed.

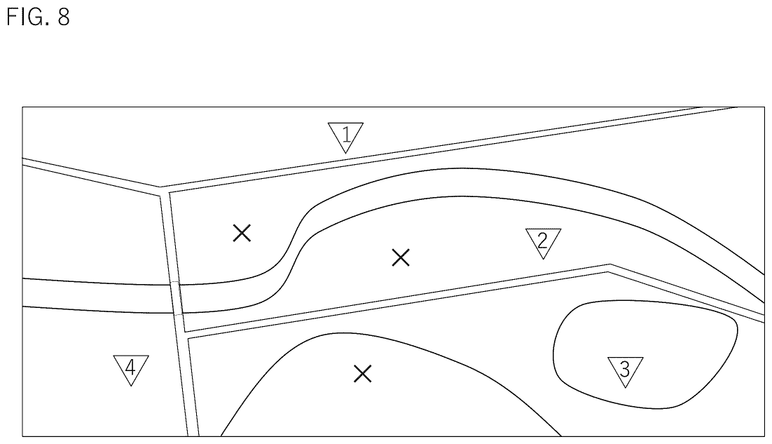

The node visualization part 16 may visualize nodes by using the locations of nodes in the network and the distance(s) between a pair(s) of nodes determined by the ranging and locating part 15, and may output a map. FIG. 8 is a schematic diagram illustrating an example of a map outputted by the node visualization part 16. As illustrated in FIG. 8, the node visualization part 16 can place the nodes outputted in FIG. 7 on a topographic map. In this case, coordinate values indicated by the above (x,y) may be represented by values based on the longitude and latitude, and the nodes may be placed on a topographic map based on these values.

### [Description of Operation]

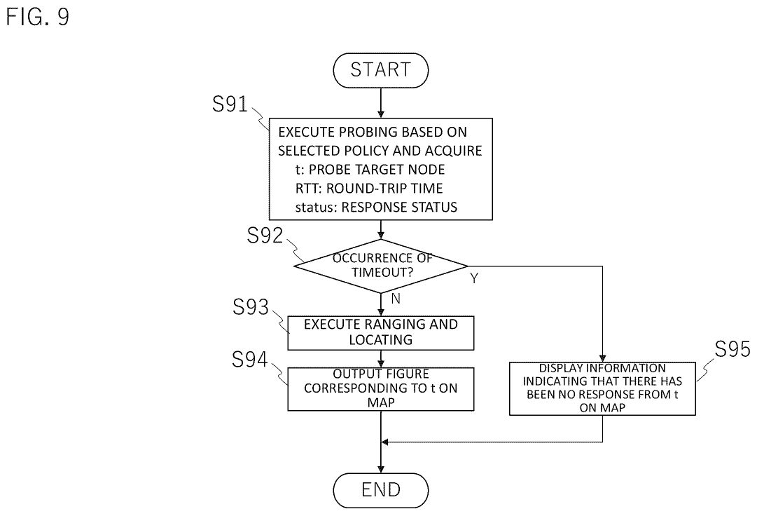

FIG. 9 is a flowchart illustrating an operation of the monitoring apparatus 10 according to the second example embodiment, in particular, operations of the probe part 12, the ranging and locating part 15, and the node visualization part 16. First, before the operation, the policy selection part 14 selects a policy. The probe part 12 executes probing based on the selected policy and acquires t: probe target node, RTT: round-trip time, status: response status, etc. (step S91). Based on the acquired result, the probe part 12 determines whether a timeout has occurred (step S92). If a timeout has not occurred (N in step S92), the ranging and locating part 15 executes ranging and locating on the target node t (step S93). Based on the result, the node visualization part 16 outputs a figure corresponding to the target node t on a map (step S94). If the target node has timed out (Y in step S92), information indicating that there has been no response from the target node t is displayed on the map (step S95). The monitoring apparatus 10 executes the above series of steps as long as the target node t is present.

### DESCRIPTION OF ADVANTAGEOUS EFFECTS

The monitoring apparatus 10 according to the present example embodiment can locate a target node(s) by calculating the distance(s) between a pair(s) of nodes in the network and by using the distance(s). In addition, the monitoring apparatus 10 can visualize and output the result of the locating. For example, the monitoring apparatus 10 can determine the physical location(s) of a target node(s) on a map. Thus, it is possible to map and refer to the status of the target node(s). Even if there are many target nodes, the status in the network can be determined easily.

### Third Example Embodiment

A third example embodiment provides a monitoring apparatus 10 that basically has the same configuration as that of the monitoring apparatus 10 according to the above example embodiments and that can add a node(s) in the target node storage part 11 based on the status of a target node(s).

### [Configuration of Apparatus]

As in the above example embodiments, the monitoring apparatus 10 according to the third example embodiment includes a target node storage part 11, a probe part 12, a policy storage part 13, and a policy selection part 14. Because these components have already been described in the above-described example embodiments, description thereof will be omitted. Although the ranging and locating part 15 and the node visualization part 16 are not essential components, these parts may be included in the present monitoring apparatus 10. Because these components have already been described in the above-described example embodiments, description thereof will be omitted.

A feature of the present example embodiment is that the probe part 12 acquires a node(s) through which a probe packet(s) has passed, as the transmission result(s) of a probe packet(s), and based on the transmission result(s), adds the node(s) in the target node storage part 11.

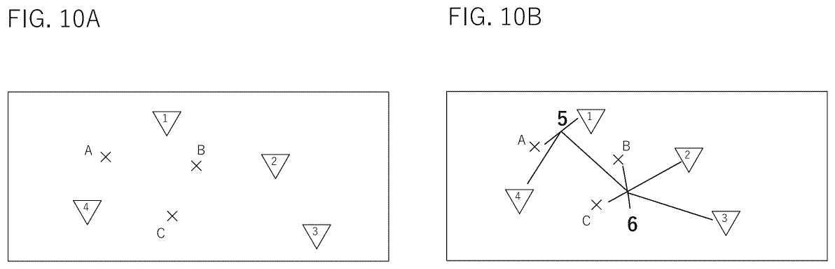

FIGS. 10A and 10B are diagrams illustrating an outline of an example of processing of the monitoring apparatus 10 according to the present example embodiment. As illustrated in FIG. 10A, first, the monitoring apparatus 10 determines that four target nodes 1 to 4 are present in a monitoring target area as a result of probing. In the subsequent probing, the monitoring apparatus 10 receives responses to probe packets from nodes 5 and 6. Thus, these nodes 5 and 6 are visualized as illustrated in FIG. 10B. Concretely, the monitoring apparatus 10 acquires paths to particular servers by using tracert commands. As a result, it is found that, because routers have changed their routing and the paths have been changed, the probe packets pass through the nodes 5 and 6 and the nodes 5 and 6 have been recognized.

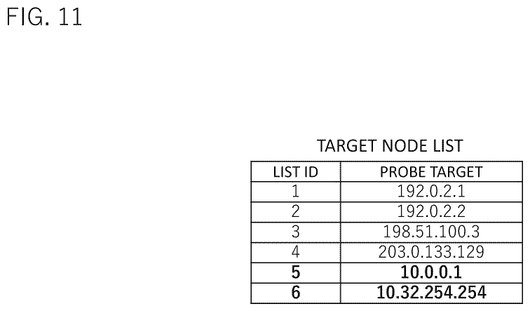

FIG. 11 is an example of a target node list stored in the target node storage part 11. As described above, if new target nodes are found by probing, first, the nodes 5 and 6, which have newly transmitted responses, are added in the target node list as probe targets.

As described in the above example embodiment, each of the physical locations of the nodes 5 and 6 (the locations on a map) can be calculated by calculating the distance from other nodes of which the physical locations are known. For example, observation points A to C in FIG. 10B transmit probe packets, and receive response packets. The individual RTT can be obtained by calculating the difference between a corresponding reception time and a corresponding transmission time. Next, the medium speed in the individual section is acquired, and the distance to each of the nodes 5 and 6 from the individual point is calculated by using the relationship “distance=(medium speed×round-trip time RTT)÷2. The physical location of the node 5 can be determined by calculating the coordinate of the intersection of a circle having a radius matching the distance between the node 5 and the observation point A, a circle having a radius matching the distance between the node 5 and the observation point B, and a circle having a radius matching the distance between the node 5 and the observation point C. The physical location of the node 6 can be determined in the same way.

### DESCRIPTION OF ADVANTAGEOUS EFFECTS

When the monitoring apparatus 10 according to the present example embodiment recognizes a new target node(s), the monitoring apparatus 10 can add the target node(s) in the target node list stored in the target node storage part. In addition, by transmitting a probe packet(s), the monitoring apparatus 10 can calculate the distance(s) to the added target node(s) and can calculate the physical location(s) of the target node(s).

### Fourth Example Embodiment

A fourth example embodiment provides a monitoring apparatus 10 that has basically the same configuration as that of the monitoring apparatus 10 according to the above example embodiments and that can specify, at the time of probing, a node(s) that the monitoring apparatus 10 preferentially probes based on the status of a target node(s), and can probes the specified node(s) in more detail.

### [Configuration of Apparatus]

As in the above example embodiments, the monitoring apparatus 10 according to the fourth example embodiment includes a target node storage part 11, a probe part 12, a policy storage part 13, and a policy selection part 14. Because these components have already been described in the above-described example embodiments, description thereof will be omitted. Although the ranging and locating part 15 and the node visualization part 16 are not essential components, these parts may be included in the present monitoring apparatus 10. Because these components have already been described in the above-described example embodiments, description thereof will be omitted.

A feature of the present example embodiment is that the probe part 12 extracts a priority target node(s) that is preferentially probed over an initial probe target node(s) based on the status of the target node(s) and probes the priority target node(s).

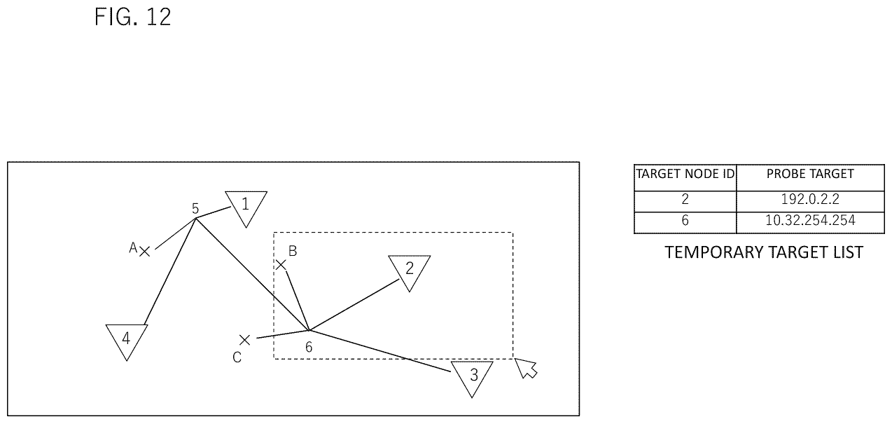

In addition, the monitoring apparatus 10 according to the present example embodiment may include a target node selection part (not illustrated). This part selects a node(s) placed on a map as a target node(s). FIG. 12 illustrates an example of a selection mode. As illustrated in FIG. 12, when a user creates a rectangle selection area with a mouse on a display screen, target nodes 2 and 6 are selected in the selection area. Accordingly, the nodes 2 and 6 are added in a temporary target list. The temporary target list inherits features of the priority target nodes, and the probe part 12 can probe the nodes 2 and 6 included in the temporary target list as the priority target nodes.

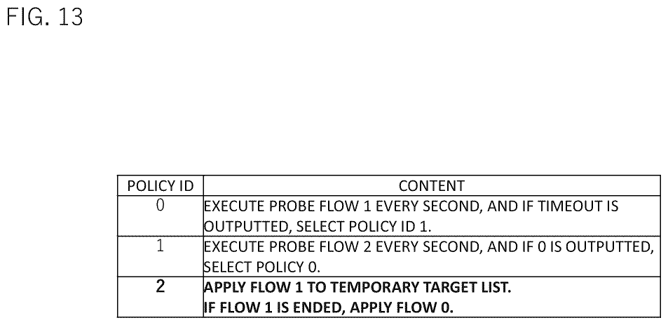

As illustrated in FIG. 13, when target nodes are added in the temporary target list, policy ID:2 is accordingly applied. When policy ID:2 is applied, flow 1 is applied to the target nodes in the list. When the probing ends, flow 0 is selected again.

In this way, because the monitoring apparatus 10 includes the target node selection part, the user can easily and intuitively select a probe target(s), and highly convenient monitoring can be executed.

### [Description of Operation]

FIGS. 14A and 14B are each a flowchart illustrating an operation of the monitoring apparatus 10 according to the present example embodiment. Flow 1 in FIG. 14A illustrates a normal operation of the monitoring apparatus 10. First, the monitoring apparatus 10 acquires an x-th target node in the target node list (x=1, 2 . . . ) (step S1401). Next, the monitoring apparatus 10 increments x (step S1402), and transmits a probe packet ping to t (step S1403). Next, the monitoring apparatus 10 calculates an RTT by using the execution result of the ping (step S1404). Next, the monitoring apparatus 10 determines whether a timeout has occurred (step S1405). If a timeout has not occurred (N in step S1405), the monitoring apparatus 10 outputs (t, RTT, successful termination) (step S1406). On the other hand, if a timeout has occurred (Y in step S1405), the monitoring apparatus 10 registers t in the priority list (step S1407), and outputs (t, 0, timeout) (step S1408).

FIG. 13 illustrates example policies stored in the policy storage part 13. The current process is being executed based on policy ID:0, and probe flow 1 is being executed every second. Policy ID:0 indicates that if a timeout occurs, policy ID:1 is selected. Policy ID:1 indicates that flow 2 is executed every second. Thus, the monitoring apparatus 10 executes flow 2 in FIG. 14B in accordance with policy ID:1. First, the monitoring apparatus 10 acquires a y-th element s (y=1, 2 . . . ) in the priority list (step S1409). Next, the monitoring apparatus 10 transmits a probe packet ping to the y-th element s (step S1410). Next, the monitoring apparatus 10 calculates an RTT by using the execution result of the ping (step S1411). Next, the monitoring apparatus 10 determines whether a timeout has occurred (step S1412). If a timeout has not occurred (N in step S1412), the monitoring apparatus 10 removes the element s from the priority list (step S1413), and acquires the number of elements in the priority list (step S1414). If a timeout has occurred (Y in step S1412), the monitoring apparatus 10 immediately acquires the number of elements in the priority list (step S1414). Next, the monitoring apparatus 10 determines whether the number of remaining elements is greater than 0 (step S1415). If the number of remaining elements is greater than 0 (not equal to 0) (Y in step S1415), the monitoring apparatus 10 increments y (step S1416), and outputs y as the number of elements in the priority list (step S1417). If the number of remaining elements is 0 or less (is equal to 0) (N in step S1415), the monitoring apparatus 10 immediately outputs y as the number of elements in the priority list (step S1417).

FIG. 13 indicates that, if 0 is output as a result of the execution of flow 2 in FIG. 14B, that is, if the number of remaining elements reaches 0, policy 0 is selected again.

### DESCRIPTION OF ADVANTAGEOUS EFFECTS

The monitoring apparatus 10 according to the present example embodiment switches the policy to be applied, by adding a target node(s) whose response to a probe packet has timed out in a priority list. By intensively transmitting more probe packets than normal to the target node(s) in the priority list, the monitoring apparatus 10 can probe the target node(s) in the network in more detail.

### Fifth Example Embodiment

In a fifth example embodiment, the probe part 12 acquires, as the transmission result(s) of a probe packet(s), at least a round-trip time(s) between transmission of the probe packet(s) and reception of a response packet(s) in response to the probe packet(s), and estimates a load condition(s) of these target node(s) based on the round-trip time(s). The fifth example embodiment provides a monitoring apparatus 10 that includes a node visualization part 16 that can execute visualization based on the load condition(s), superimpose the load condition(s) on the location(s) of the target node(s) on a map, and output the map.

### [Configuration of Apparatus]

As in the above example embodiments, the monitoring apparatus 10 according to the fifth example embodiment includes a target node storage part 11, a probe part 12, a policy storage part 13, a policy selection part 14, a ranging and locating part 15, and a node visualization part 16. Because these components have already been described in the above-described example embodiment, description thereof will be omitted.

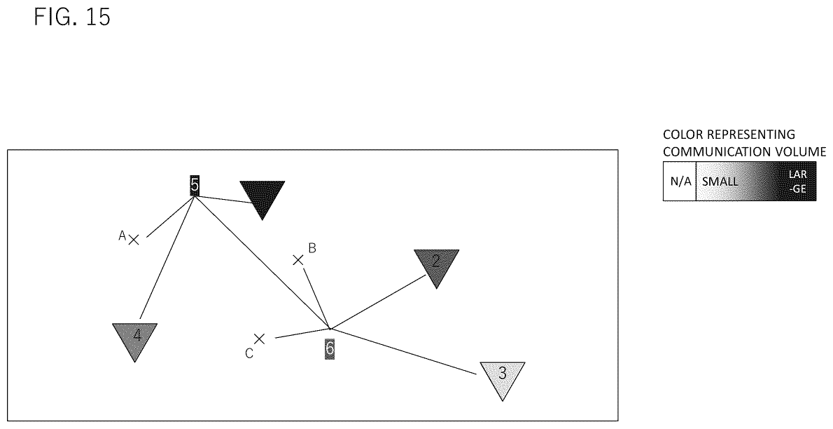

FIG. 15 is a diagram illustrating an outline of processing of the monitoring apparatus 10 according to the present example embodiment. As illustrated in FIG. 15, colors are superimposed on the individual nodes. If a node is estimated to have a larger communication volume, this node is represented by a darker color. In the present example embodiment, the probe part 12 estimates whether a node has a high load based on the magnitude of the fluctuation (variance) of the round-trip time obtained based on probe packets. In addition, the monitoring apparatus 10 assumes that the high load of a node connected to a network is due to a large communication volume, and visualizes the communication volume with color intensity.

As described above, the monitoring apparatus 10 according to the present example embodiment can visualize and output the communication volume as a probe result. In this way, the user can immediately determine the status of the target node(s).

The above-described example embodiments can partially or entirely be described, but not limited to, as the following modes.

### [Mode 1]

See the monitoring apparatus according to the above-described first aspect.

### [Mode 2]

The monitoring apparatus preferably according to mode 1; wherein the probe part transmits a probe packet(s) based on the selected policy(ies); and wherein the policy selection part selects a policy(ies) based on a transmission result(s) of the probe packet(s).

### [Mode 3]

The monitoring apparatus preferably according to mode 2; wherein the probe part acquires a round-trip time (RTT) value(s) as a transmission result(s) of the probe packet(s); and wherein the policy selection part selects a policy(ies) based on the RTT value(s).

### [Mode 4]

The monitoring apparatus preferably according to mode 2; wherein the probe part acquires a node(s) through which the probe packet(s) has passed, as a transmission result(s) of the probe packet(s), and adds, based on the transmission result(s), the node(s) in the target node storage part.

### [Mode 5]

The monitoring apparatus preferably according to any one of modes 2 to 4, further comprising a ranging and locating part that determines a distance(s) between a pair(s) of nodes in the network and locations of nodes, wherein the probe part acquires a node(s) through which the probe packet(s) has passed, as a transmission result(s) of the probe packet(s); and wherein the ranging and locating part uses the transmission result(s) to determine a distance(s) between a pair(s) of nodes in the network and locations of nodes.

### [Mode 6]

The monitoring apparatus preferably according to mode 5, further comprising a node visualization part that visualizes nodes by placing the nodes on a map from a distance(s) between a pair(s) of nodes in the network and locations of nodes, and outputs the map, wherein the node visualization part visualizes the nodes on the map by using the locations of the nodes in the network and the distance(s) between the pair(s) of nodes determined by the ranging and locating part, and outputs the map.

### [Mode 7]

The monitoring apparatus preferably according to mode 1 or 2; wherein the probe part extracts a priority target node(s) that is probed preferentially over an initial probe target node(s) based on the status of the target node(s), and probes the priority target node(s).

### [Mode 8]

The monitoring apparatus preferably according to mode 7, further comprising a target node selection part that selects a node(s) placed on a map as a target node(s); wherein the probe part probes the target node(s) as a priority target node(s).

### [Mode 9]

The monitoring apparatus preferably according to mode 6; wherein the probe part acquires, as a transmission result(s) of the probe packet(s), at least a round-trip time(s) between transmission of a probe packet(s) and reception of a response packet(s) in response to the probe packet(s), and estimates a load condition(s) of the target node(s) based on the round-trip time(s); and wherein the node visualization part executes visualization based on the load condition(s), superimposes the load condition(s) on the location(s) of the target node(s) on a map, and outputs the map.

### [Mode 10]

See the monitoring method according to the above-described second aspect.

### [Mode 11]

See the program according to the above-described third aspect. Modes 10 and 11 can be expanded in the same way as mode 1 is expanded to modes 2 to 9.

The disclosure of the above PTL, etc., which have been referred to, is incorporated herein by reference thereto. Modifications and adjustments of the example embodiment and examples are possible within the scope of the overall disclosure (including the claims) of the present invention and based on the basic technical concept of the present invention. Various combinations and selections of various disclosed elements (including the elements in each of the claims, example embodiments, examples, drawings, etc.) are possible within the scope of the overall disclosure of the present invention. That is, the present invention of course includes various variations and modifications that could be made by those skilled in the art according to the overall disclosure including the claims and the technical concept. The specification discloses numerical value ranges. However, even if the specification does not particularly disclose numerical values or small ranges included in the ranges, these values and ranges should be deemed to have been explicitly disclosed.

### REFERENCE SIGNS LIST

10: monitoring apparatus
11: target node storage part
12: probe part
13: policy storage part
14: policy selection part
15: ranging and locating part
16: node visualization part
18: path storage part
51: CPU
52: memory
53: input-output interface
54: NIC
55: internal bus

What is claimed is:

1. A monitoring apparatus, comprising:
a target node storage part that stores a target node(s), which is a probe target(s) in a network;
a probe part that acquires a status of the target node(s) via the network and probes the status;
a policy storage part that stores a probe policy(ies) defining a policy(ies) for probing the probe target node(s); and
a policy selection part that selects one or more of the probe policy(ies) based on the status of the target node(s);
wherein the probe part probes the target node(s) stored in the target node storage part based on the selected policy(ies).

2. The monitoring apparatus according to claim 1;
wherein the probe part transmits a probe packet(s) based on the selected policy(ies); and
wherein the policy selection part selects a policy(ies) based on a transmission result(s) of the probe packet(s).

3. The monitoring apparatus according to claim 2;
wherein the probe part acquires a round-trip time (RTT) value(s) as a transmission result(s) of the probe packet(s); and
wherein the policy selection part selects a policy(ies) based on the RTT value(s).

4. The monitoring apparatus according to claim 2; wherein the probe part acquires a node(s) through which the probe packet(s) has passed, as a transmission result(s) of the probe packet(s), and adds, based on the transmission result(s), the node(s) in the target node storage part.

5. The monitoring apparatus according to claim 2, further comprising a ranging and locating part that determines a distance(s) between a pair(s) of nodes in the network and locations of nodes,
wherein the probe part acquires a node(s) through which the probe packet(s) has passed, as a transmission result(s) of the probe packet(s); and
wherein the ranging and locating part uses the transmission result(s) to determine a distance(s) between a pair(s) of nodes in the network and locations of nodes.

6. The monitoring apparatus according to claim 5, further comprising a node visualization part that visualizes nodes by placing the nodes on a map from a distance(s) between a pair(s) of nodes in the network and locations of nodes, and outputs the map,
wherein the node visualization part visualizes the nodes on the map by using the locations of the nodes in the network and the distance(s) between the pair(s) of nodes determined by the ranging and locating part, and outputs the map.

7. The monitoring apparatus according to claim 1; wherein the probe part extracts a priority target node(s) that is probed preferentially over an initial probe target node(s) based on the status of the target node(s), and probes the priority target node(s).

8. The monitoring apparatus according to claim 7, further comprising a target node selection part that selects a node(s) placed on a map as a target node(s); wherein the probe part probes the target node(s) as a priority target node(s).

9. The monitoring apparatus according to claim 6;
wherein the probe part acquires, as a transmission result(s) of the probe packet(s), at least a round-trip time(s) between transmission of a probe packet(s) and reception of a response packet(s) in response to the probe packet(s), and estimates a load condition(s) of the target node(s) based on the round-trip time(s); and
wherein the node visualization part executes visualization based on the load condition(s), superimposes the load condition(s) on the location(s) of the target node(s) on a map, and outputs the map.

10. A monitoring method, causing a computer to execute:
acquiring a target node(s), which is a probe target(s) in a network;
acquiring a probe policy(ies) defining a policy(ies) for probing the probe target(s);
selecting one or more of the probe policy(ies) based on a status of the target node(s); and
acquiring, based on the selected policy(ies), the status of the target node(s) via the network and probing the status.

11. The monitoring method according to claim 10, further comprising;
transmitting a probe packet(s) based on the selected policy(ies); and
selecting a policy(ies) based on a transmission result(s) of the probe packet(s).

12. The monitoring method according to claim 11, further comprising;
acquiring a round-trip time (RTT) value(s) as a transmission result(s) of the probe packet(s); and
selecting a policy(ies) based on the RTT value(s).

13. The monitoring method according to claim 11, further comprising;
acquiring a node(s) through which the probe packet(s) has passed, as a transmission result(s) of the probe packet(s), and
adding, based on the transmission result(s), the node(s) in a target node storage.

14. The monitoring method according to claim 11, further comprising:
determining a distance(s) between a pair(s) of nodes in the network and locations of nodes,
acquiring a node(s) through which the probe packet(s) has passed, as a transmission result(s) of the probe packet(s); and
using the transmission result(s) to determine a distance(s) between a pair(s) of nodes in the network and locations of nodes.

15. The monitoring method according to claim 14, further comprising:
visualizing nodes by placing the nodes on a map from a distance(s) between a pair(s) of nodes in the network and locations of nodes, and outputs the map,
wherein the visualizing comprises visualizing the nodes on the map by using the locations of the nodes in the network and the distance(s) between the pair(s) of nodes determined by the ranging and locating, and outputs the map.

16. The monitoring method according to claim 10, further comprising;
extracting a priority target node(s) that is probed preferentially over an initial probe target node(s) based on the status of the target node(s),
and probing the priority target node(s).

17. The monitoring method according to claim 16, further comprising selecting a node(s) placed on a map as a target node(s); thereby probing the target node(s) as a priority target node(s).

18. The monitoring method according to claim 15, further comprising;
acquiring, as a transmission result(s) of the probe packet(s), at least a round-trip time(s) between transmission of a probe packet(s) and reception of a response packet(s) in response to the probe packet(s), and to estimate a load condition(s) of the target node(s) based on the round-trip time(s); and
executing visualization based on the load condition(s), superimposing the load condition(s) on the location(s) of the target node(s) on a map, and outputting the map.

19. A computer readable, non-transitory storage medium storing a program, the program causing a computer to execute processings of:
acquiring a target node(s), which is a probe target(s) in a network;
acquiring a probe policy(ies) defining a policy(ies) for probing the probe target(s);
selecting one or more of the probe policy(ies) based on a status of the target node(s); and
acquiring, based on the selected policy(ies), the status of the target node(s) via the network and probing the status.

20. The medium according to claim 19;
wherein the program causes the computer to execute: transmitting a probe packet(s) based on the selected policy(ies); and
selecting a policy(ies) based on a transmission result(s) of the probe packet(s).
